(19) United States
(12) Patent Application Publication
(10) Pub. No.: US 2026/0161916 A1
(43) Pub. Date: Jun. 11, 2026

(54) NEAR-FIELD COMMUNICATION METAL CARD

(71) Applicant: IDEMIA FRANCE, Courbevoie (FR)

(72) Inventors: Agnès DUVAL, Courbevoie (FR); Tiphaine GROULT, Courbevoie (FR); Oumar BARRO, Courbevoie (FR)

(73) Assignee: IDEMIA FRANCE, Courbevoie (FR)

(21) Appl. No.: 19/409,366

(22) Filed: Dec. 4, 2025

(30) Foreign Application Priority Data
Dec. 5, 2024 (FR) FR2413469

(51) Int. Cl. G06K 19/04; H01Q 7/00

(52) U.S. Cl. CPC G06K 19/041; H01Q 7/00

(57) ABSTRACT

A near-field contactless smart card is provided that includes a card body having at least one metal layer, a first antenna layer and a second antenna layer; a chip, disposed opposite an opening in the metal layer, with a first antenna formed on a surface of the first antenna layer and connected to the chip, and a passive electronic component, with a second antenna formed on a surface of the second antenna layer and electronically connected to the component.

### TECHNICAL FIELD OF THE INVENTION

The invention relates to a near-field communication card, also denoted “NFC”. Near-field communication is a wireless communication technology that allows data to be exchanged between two devices separated by a short distance, generally a few centimetres. NFC is commonly used in various devices, such as smartphones, credit cards, and other compatible devices for making contactless payments, sharing information, or even establishing instant connections with other NFC objects. The present invention in this case relates to a card, such as a debit card, a credit card, an identification card, a loyalty card, a membership card, a healthcare card, a security card, etc.

More specifically, the invention relates to a metal card, i.e., a card comprising a body that includes a metal substrate.

### PRIOR ART

The market for “smart” cards imposes increasingly stringent aesthetic constraints, notably with respect to “NFC RFID” smart cards, i.e., contactless NFC cards with RFID (Radio Frequency Identification) chips, which in most cases operate in a frequency range of approximately 13.56 MHz, for example, for banking, transport, automotive or identification applications.

A metal card in this case refers to a card whose substrate, which forms a substantial portion of the card body, comprises, depending on its thickness, at least one metal sheet, or even is essentially made up of a metal sheet or plate, which can be machined, etched, painted and/or varnished as required.

The card considered in this case is a “smart card”, which therefore incorporates a metal structure into its design.

A metal card thus presents challenges in terms of near-field communication, as the presence of metal can alter the performance of an antenna generally contained within the body of the card for establishing near-field contactless communication.

Consequently, special technical solutions, such as specific antennas and adapted manufacturing processes, are developed to ensure that the card functions acceptably despite the presence of metal for forming the body of the card.

One of the main current demands relates to the metal smart cards as described above, which can further comprise at least one passive electronic component, for example, such as an LED (“Light-Emitting Diode”, i.e., an electroluminescent diode), an OLED (“Organic Light-Emitting Diode”, i.e., an organic electroluminescent diode), notably an LED or an OLED connected to a diode bridge, a diode bridge, a piezoelectric component at least partially made of ceramic, a screen, a sensor, or the like.

This type of card is designed to meet specific aesthetic and functional requirements within the context of contactless NFC RFID applications.

Therefore, an aim of the present invention is to propose a metal card that can operate contactlessly and can further comprise at least one passive electronic component, for example, such as those mentioned above.

### DISCLOSURE OF THE INVENTION

To this end, according to a first aspect of the invention, a metal smart card is proposed that is configured for contactless near-field operation, the card comprising:
a card body formed by a stack of layers, the stack of layers comprising at least:
   a metal layer, the metal layer being delimited by a peripheral edge defining a perimeter of the card body, and the metal layer comprising an opening formed at a distance from the peripheral edge;
   a first antenna layer disposed on a first side of the metal layer, distinct from the metal layer,
   a second antenna layer distinct from the first antenna layer and the metal layer,
a chip, disposed opposite the opening in the metal layer,
a first antenna formed on a surface of the first antenna layer (120), the first antenna being electronically connected to the chip (11), the first antenna comprising at least one first set of turns comprising at least one turn, called external turn, following the perimeter of the card body (10), and the first antenna comprising at least one second set of turns comprising at least one turn, called internal turn, surrounding the chip, or even surrounding the metal layer, the first set of turns of the first antenna being distinct from the second set of turns of the first antenna, and the first set of turns of the first antenna being electrically connected to the second set of turns of the first antenna by at least one section of antenna wire,
a passive electronic component,
a second antenna formed on a surface of the second antenna layer, the second antenna being electronically connected to the passive electronic component, the second antenna comprising at least one first set of turns comprising at least one turn, called external turn, following the perimeter of the card body, the first set of turns of the second antenna being disposed opposite the first set of turns of the first antenna, and the second antenna comprising at least one second set of turns comprising at least one turn, called internal turn, surrounding the chip, or even surrounding the metal layer, the second set of turns of the second antenna being disposed opposite the second set of turns of the first antenna, the first set of turns of the second antenna being distinct from the second set of turns of the second antenna, and the first set of turns of the second antenna being electrically connected to the second set of turns of the second antenna by at least one section of antenna wire.

The card according to the invention notably comprises an additional layer comprising an antenna electrically connected to a passive electronic component, such as an LED or an OLED, optionally connected to a diode bridge, a piezoelectric ceramic component, a screen, a sensor or the like.

The invention thus proposes a metal NFC card structure comprising an HF (high frequency) RFID antenna, suitable for HF RFID applications as defined by the ISO 10373/14443/15693 communication protocol or any other HF RFID near-field communication scheme.

The invention thus proposes an antenna arrangement suitable for contactless metal NFC RFID smart cards, capable of operating in the frequency range of approximately 13.56 MHz, for example, for banking (payment), transport, automotive or identification applications.

The card according to the invention is particularly suitable for purely contactless NFC metal cards and dual NFC metal cards.

Such a metal card eliminates the need for ferrite material for forming the metal layer.

Such a card also allows symmetrical behaviour on both sides of the card, while including a passive electronic component.

Each antenna comprises two sets of turns.

A set of turns comprises, for example, at least two turns, with the at least two turns being spaced apart from each other by a distance, called “inter-turn distance”.

In addition, for each antenna, the first set of turns is spaced apart from the second set of turns by a distance, called “inter-set distance”, which is greater than the “inter-turn distance”.

For example, the innermost turn from among the turns of the first set of turns is spaced apart, by the inter-set distance, from the outermost turn from among the turns of the second set of turns.

The two sets of turns in an antenna are thus clearly visually distinct.

An antenna comprising two sets of turns allows eddy current energy to be picked up from the metal layer, thereby improving the symmetrical behaviour of the card in the magnetic field.

As eddy currents flow in closed loops, the outermost loop (i.e., the largest turn), corresponding to the longest path of the eddy currents, is then the most dominant turn in terms of the energy it conveys.

An advantage of assembling two antennas in a card according to the invention is that a current induced in the first antenna allows the chip to be powered, and that a current induced in the second antenna allows the passive electronic component to be powered.

In one embodiment, the card comprises at least one electrically insulating layer.

For example, the electrically insulating layer is disposed between the metal layer and at least one from among the first antenna layer and the second antenna layer.

In one embodiment, the metal layer is disposed between the first antenna layer and the second antenna layer.

In one embodiment, the second antenna layer is disposed between the first antenna layer and the metal layer.

In one embodiment, the passive electronic component is opposite the chip.

In one embodiment, the passive electronic component is laterally offset relative to the opening.

In one embodiment, the card comprises a non-magnetic dielectric material.

For example, the non-magnetic dielectric material fills the opening.

In one embodiment, the metal layer comprises at least one first slot extending between the opening and a peripheral edge of the metal layer.

For example, one edge of the first slot connects a perimeter of the opening to the peripheral edge of the metal layer.

In one embodiment, the metal layer comprises at least one second slot.

For example, the second slot is blind.

For example, the second slot extends into the metal layer from the opening of the metal layer.

In one embodiment, the card comprises a module inserted into a cavity in the card body.

For example, the module comprises the chip.

In one embodiment, the card comprises at least one upper coating layer.

In one embodiment, the card comprises at least one lower coating layer.

For example, the two antenna layers and the metal layer are disposed between the upper coating layer and the lower coating layer.

In one embodiment, the passive electronic component comprises an LED, an OLED, an LED or OLED connected to a diode bridge, a ceramic piezoelectric component, a screen, a sensor, liquid crystals or a capacitor.

### BRIEF DESCRIPTION OF THE FIGURES

The invention, according to one embodiment, will be fully understood and its advantages will become apparent upon reading the following detailed description, which is provided by way of a non-limiting example, with reference to the accompanying drawings, in which:

FIG. 1 shows a schematic cross-sectional view of a metal card according to one embodiment of the present invention;

FIG. 2 schematically illustrates a top view of a metal layer assembled with a first antenna layer of a card as illustrated in FIG. 1;

FIG. 3 schematically illustrates a top view of a second antenna of a card as illustrated in FIG. 1;

FIG. 4 illustrates an arrangement in which a second antenna layer is disposed between a first antenna layer and a metal layer, and in which the metal layer comprises an opening, called “central” opening;

FIG. 5 illustrates an arrangement in which a second antenna layer is disposed between a first antenna layer and a metal layer, and in which the metal layer comprises an opening for a module for a card of the “dual” card type;

FIG. 6 illustrates an arrangement in which a metal layer is disposed between a first antenna layer and a second antenna layer, and in which the metal layer comprises an opening, called “central” opening;

FIG. 7 illustrates an arrangement in which a metal layer is disposed between a first antenna layer and a second antenna layer, and in which the metal layer comprises an opening for a module for a card of the “dual” card type; and

FIG. 8 illustrates a functional schematic diagram of the card according to one embodiment of the invention.

### DETAILED DESCRIPTION

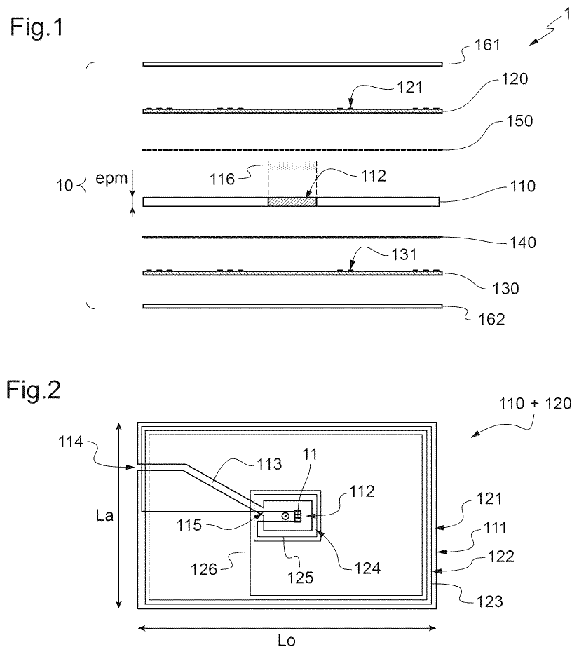

FIG. 1 schematically illustrates a structure of a metal NFC “smart” card 1 according to one embodiment.

A card 1 as considered herein comprises at least one body 10, which is formed by a stack of layers. The body 10 has dimensions (length Lo, width La, thickness ep, with the thickness ep being orthogonal to the length Lo and the width La schematically illustrated in FIG. 2) that define the dimensions of the card 1.

In the case of a metal card, the body 10 comprises at least one metal layer 110.

The metal layer 110 in this case can be formed by any metal material, which may not be ferritic.

For example, the metal layer can comprise copper, aluminium, gold, stainless steel or any other material plated with a metal coating of the aforementioned type.

The metal layer comprises a peripheral edge 111 (illustrated in FIG. 2), which thus defines a perimeter (or lateral surface) of the card body.

The metal layer 110 has a width La and a length Lo, measured along its peripheral edge 111, that define the width and the length of the body 10 of the card 1, and therefore incidentally the corresponding dimensions of the card 1.

The metal layer thus covers the entire surface of the card.

The metal layer comprises a first face and a second face, opposite each other and substantially parallel to each other.

The first face and the second face thus together define a thickness epm of the metal layer (illustrated in FIG. 1).

As shown in FIG. 1, the card body further comprises a first antenna layer 120.

The first antenna layer 120 is distinct from the metal layer 110.

The first antenna layer 120 is disposed on one side of the first face of the metal layer 110.

In the diagram in FIG. 1, the first antenna layer 120 is disposed above the metal layer 110.

The card body further comprises a second antenna layer 130.

The second antenna layer 130 is distinct from the first antenna layer 120 and the metal layer 110.

The second antenna layer 130 in this case is disposed on one side of the second face of the metal layer 110.

In the diagram in FIG. 1, the second antenna layer 130 is disposed below the metal layer 110.

However, as described hereafter, the first antenna layer 120 and the second antenna layer 130 can be disposed on the same side of the metal layer 110.

The card body in this case also comprises an upper coating layer (often referred to as an overlay) 161 and a lower coating layer (overlay) 162.

The overlays are layers that are generally disposed on the free surface of the card body.

The overlays are generally added to the card for aesthetic printing and/or security features (identification and/or authentication of a card in relation to its holder), which are well known in the smart card industry.

In this case, the two antenna layers 120, 130 and the metal layer 110 are therefore disposed between the upper coating layer 161 and the lower coating layer 162.

At least one from among the upper coating layer 161 and the lower coating layer 162 is, for example, a plastic layer, or, for example, both coating layers 161, 162 are made of plastic.

According to an option illustrated in FIG. 1, the card body further comprises at least one electrically insulating layer 140, 150.

Such an electrically insulating layer 140, 150 is disposed between the metal layer 110 and the first antenna layer 120 and/or the second antenna layer 130.

Such an electrically insulating layer 140, 150 forms a protective layer and is configured to improve the adhesion between the metal layer 110 and one of the antenna layers 120, 130.

The electrically insulating layer 140, 150 comprises, for example, a resin layer or an adhesive, for example, a dielectric resin layer.

A dielectric resin allows the metal layer to be attached to its adjacent upper and lower layers.

In this case, an electrically insulating layer 150 is disposed between the metal layer 110 and the first antenna layer 120, and another electrically insulating layer 140 is disposed between the metal layer 110 and the second antenna layer 130.

FIG. 2 schematically illustrates a top view of the metal layer 110 assembled with the first antenna layer 120.

As shown in this figure, the metal layer comprises an opening 112.

The opening 112 is formed remote from the peripheral edge 111 of the metal layer 110.

The opening 112 can assume any type of shape; it can assume a regular shape such as a rectangle, a circle, or any other regular or irregular geometric shape. It generally assumes a round or rectangular shape, or even a square shape. The opening can also optionally comprise rounded corners.

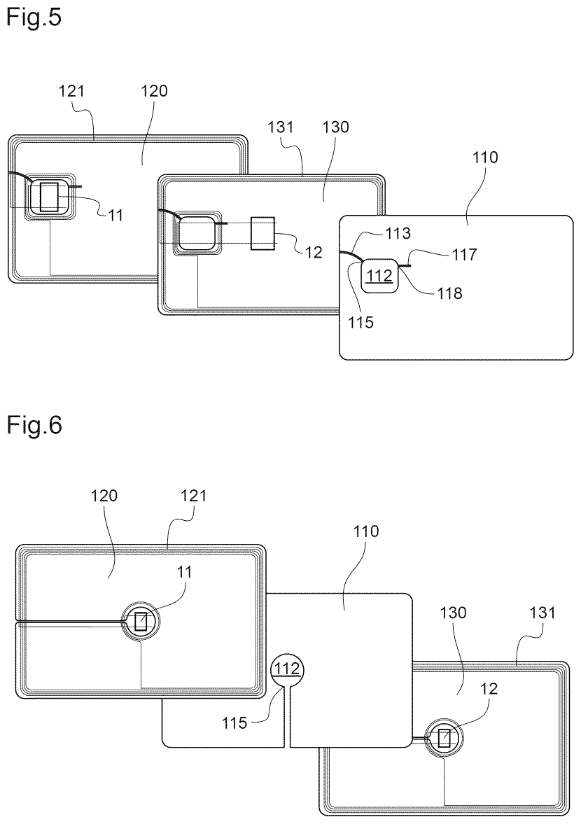

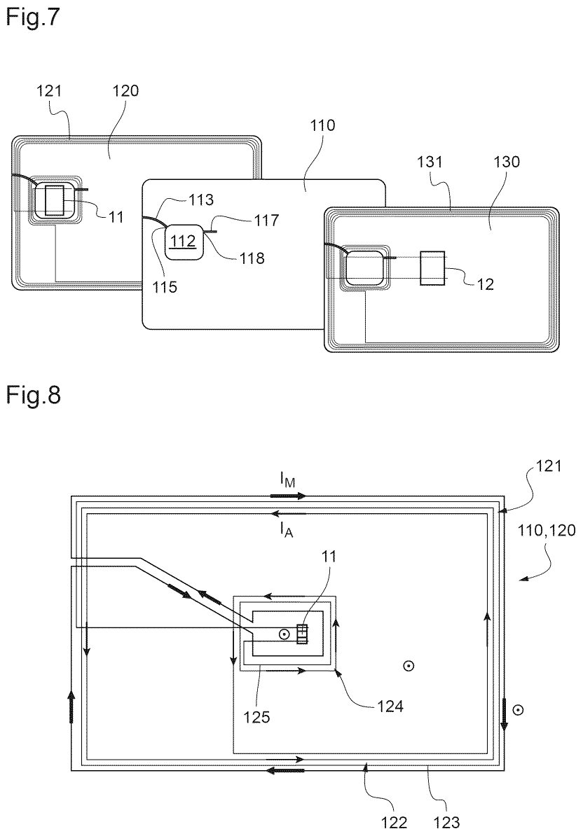

The opening can be formed in a central portion of the card (as illustrated in FIGS. 2, 4, 6 and 8, for example), or can be off-centre (as illustrated in FIGS. 5 and 7, for example), notably in the case of a “dual” card.

In a configuration where the opening is centred, the centre of the opening is preferably located at the geometric centre of the card 1, as anticipated in the EMVCO standards, for example; for ID1 cards, the geometric centre is considered to be the central reference point of a test plane.

However, the opening can be off-centre along the length and/or the width of the card. It can coincide with the cavity of the dual module. This is of particular interest because the modules can assume several irregular shapes. The size of the cavity can be considerably reduced to a cavity with a diameter of 1 cm (smaller than an “M3” module, with an M3 module referring to a small module format, for example, with dimensions of approximately 11+/−0.2 mm×82+/−0.2 mm, for example, 10.85 mm*8.17 mm).

In one embodiment of a dual card, i.e., one that can operate with or without contact, the card then comprises an electronic module inserted into a cavity in the card, and this cavity can then optionally coincide with the opening in the metal layer, i.e., can be arranged opposite the opening 112.

Such a module, then comprising the chip 11, is known in the field of dual cards and is not described in further detail herein.

For example, for a dual card, a cavity is previously formed in the metal layer, then it is assembled with the other layers, then a cavity is perforated in these other layers in order to join the cavity in the metal layer and insert the module into it.

In one embodiment, the card can comprise a non-magnetic dielectric material 116 that can be used to fill the opening 112.

This material can comprise a resin, for example, the same resin as that forming the at least one electrically insulating layer 140, 150.

The non-magnetic dielectric material 116 can comprise a mechanically stiffening material, such as, for example, ceramic, stone, wood, or even rubber, for example, hard rubber.

The non-magnetic dielectric material 116 also can be transparent, for example, using tempered glass or a transparent polycarbonate filler material.

In this embodiment, the metal layer 110 further comprises a first slot 113.

The first slot 113 in this case connects the opening 112 to the peripheral edge 111 of the metal layer.

Thus, the peripheral edge 111, the edges of the first slot 113 and a perimeter of the opening 112 form a continuous lateral surface of the metal layer 110.

For example, the first slot 113 opens at the peripheral edge 111 at a mouth 114.

For example, the first slot 113 opens into the opening 112 at a mouth 115.

The mouth 114 can be, for example, offset from the mouth 115, relative to an edge of the metal layer comprising the mouth 114.

In one embodiment, the first slot 113 can comprise a straight section and/or a curved section.

In the embodiment of FIG. 2, the first slot 113 comprises a first section comprising the mouth 114 that orthogonally extends to a portion of the peripheral edge 111 that comprises the mouth 114.

In the embodiment of FIG. 2, the first slot 113 comprises a second section comprising the mouth 115 that obliquely extends relative to the first section.

In this case, the first section and the second section are straight.

However, at least one of the sections could be curved.

For example, in the embodiments of FIGS. 4 and 6 described hereafter, the first slot 113 only comprises a straight section, orthogonally extending to an edge of the metal layer, and the mouth 114 is opposite the mouth 115.

According to another example, as illustrated in FIGS. 5 and 7 described hereafter, the first slot 113 only comprises a curved section, and the mouth 114 is offset relative to the mouth 115.

According to another option, in this case illustrated in FIGS. 5 and 7, the metal layer 110 comprises a second slot 117.

The second slot 117 is blind, for example.

The second slot 117 extends, for example, into the metal layer from the opening 112, from a mouth 118, distinct from the mouth 115 of the first slot 113.

The second slot 117 can comprise a straight section and/or a curved section.

In the examples shown, the second slot 117 only comprises a straight section.

As is also illustrated in FIG. 2, the body 10 comprises a first antenna 121.

The first antenna 121 in this case is an RFID antenna, for example, a high-frequency (HF) antenna.

The first antenna 121 is arranged in a physical layer distinct from the metal layer, in this case on a surface of the first antenna layer 120.

The first antenna 121 is formed, for example, from a metal wire.

The first antenna 121 is disposed so as to comprise at least two sets of turns:
a first set of turns 122 is arranged along the peripheral edge 111 of the metal layer 110; this set comprises at least one turn 123, then spirals towards a centre of the metal layer;
a second set 124 of turns is arranged around a perimeter of the opening 112 formed in the metal layer, so as to encircle the opening 112 with at least one turn 125.

The two sets of turns are continuously electrically connected, for example, by a section of antenna wire 126.

A winding direction of the metal wire forming the first antenna 121, from the outermost turn 123 towards the innermost turn 125, is such that the current I_{A} flows in the same direction in both turns, as illustrated in FIG. 8, for example.

The card 1 further comprises a microcontroller 11, also referred to as a chip 11, i.e., a secure electronic element.

The chip 11 is configured to communicate with an external reader by means of the first antenna 121.

The first antenna 121 is therefore, for example, tuned to the appropriate frequency in relation to the input impedance of the chip 11 in order to meet the requirements of the intended communication standards, for example, such as the ISO 10373, ISO 14443, ISO 18745, EMVCo, or even ISO 15693 standards.

The first antenna 121 is connected to the chip 11 using techniques that are well known in the field of smart cards and antennas.

As illustrated in FIG. 2, one end of the antenna, for example a terminal point of the largest turn 123, is electrically connected to a first antenna terminal of the chip 11, and a terminal point of the smallest turn 125 is electrically connected to a second antenna terminal of the chip 11.

The chip 11 can be mounted, for example, on a surface of the first antenna layer 120.

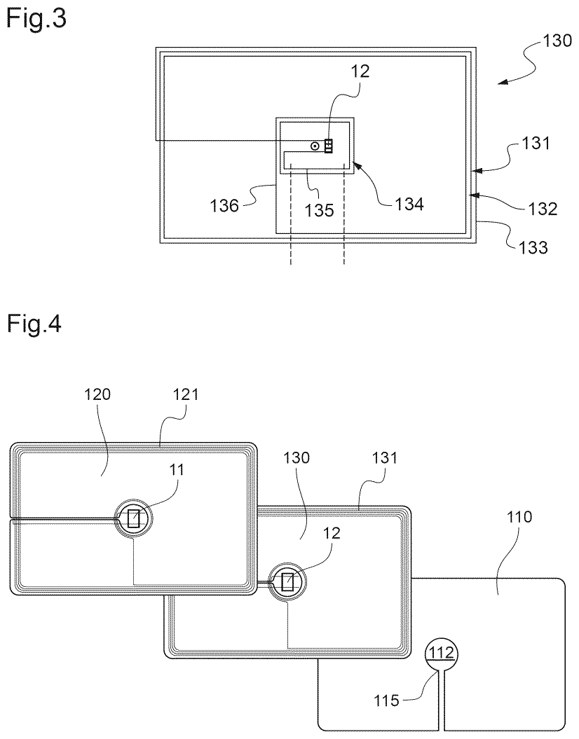

As is further illustrated in FIG. 3, the body 10 comprises a second antenna 131.

The second antenna 131 in this case is an RFID antenna, for example, a high-frequency (HF) antenna.

The second antenna 131 is arranged in a physical layer distinct from the metal layer, in this case on a surface of the second antenna layer 130.

The second antenna 131 is formed from a metal wire, for example.

The second antenna 131 is disposed so as to comprise at least two sets of turns:
a first set of turns 132 is arranged along the peripheral edge 111 of the metal layer 110; this set comprises at least one turn 133, then spirals towards a centre of the metal layer;
a second set 134 of turns is arranged around a perimeter of the opening 112 formed in the metal layer, so as to encircle the opening 112 with at least one turn 135.

The two sets of turns are continuously electrically connected, for example, by a section of antenna wire 136.

A winding direction of the metal wire forming the second antenna 131, from the outermost turn 133 towards the innermost turn 125, is such that the current flows in the same direction in both turns.

The card 1 further comprises a passive electronic component 12.

The passive electronic component 12 comprises, for example, an LED or an OLED, optionally connected to a diode bridge, a piezoelectric ceramic component, a screen, or a sensor.

The second antenna 131 is connected to the passive electronic component 12 by means of techniques similar to those used to connect the chip 11 to the first antenna 121.

As illustrated in FIG. 3, one end of the second antenna 131, for example a terminal point of the largest turn 133, is electrically connected to a first terminal of the passive electronic component 12, and a terminal point of the smallest turn 135 is electrically connected to a second terminal of the passive electronic component 12.

The passive electronic component 12 can be mounted, for example, on a surface of the second antenna layer 130.

For example, the passive electronic component 12 can be visible from outside the card 1. To this end, the upper coating layer 161 or the lower coating layer 162 covering the passive electronic component 12 can comprise an orifice and/or at least one transparent area.

FIGS. 4 to 7 illustrate examples of the arrangement of the metal layer 11, the first antenna layer 120, and the second antenna layer 130.

In FIGS. 4 and 5, the second antenna layer 130 is disposed between the first antenna layer 120 and the metal layer 110.

The metal layer 110 then can be below the two antenna layers, as schematically shown in FIG. 4, or above them, as schematically shown in FIG. 5.

In the example of FIG. 4, the first antenna layer 120 is then considered to be above the second antenna layer 130 and the metal layer 110, while, in the example of FIG. 5, the first antenna layer 120 is then considered to be below the second antenna layer 120 and the metal layer 110.

In FIGS. 6 and 7, the metal layer 110 is disposed between the first antenna layer 120 and the second antenna layer.

The first antenna layer 120 then can be above the metal layer, as schematically shown in FIG. 6, which corresponds to a stack as illustrated in FIG. 1, or below the metal layer, as schematically shown in FIG. 7.

In the example of FIG. 6, the second antenna layer 130 is then considered to be below the metal layer 110, while, in the example of FIG. 7, the second antenna layer 130 is then considered to be above the metal layer 110.

Thus, the HF RFID antenna and the antenna connected to a passive electronic component can be on the same side of the metal layer, or on each side of the metal layer.

However, disposing the first antenna layer and the second antenna layer on either side of the metal layer 110 provides better mechanical symmetry for the card, as the antennas are then disposed on each side of the metal layer.

The card 1 can be a purely contactless HF RFID card or a dual card.

For example, FIGS. 4 and 6 illustrate embodiments of purely contactless card designs.

In these embodiments in FIGS. 4 and 6, the chip 11 and the passive electronic component 12 are disposed overlaying one another, and opposite the opening 112 in the metal layer 110.

However, FIGS. 5 and 7 illustrate embodiments of a dual card.

In these embodiments, the chip 11 is opposite the opening 112 in the metal layer 110, while the passive electronic component 12 is laterally offset relative to the opening 112 in the metal layer 110 and is thus opposite a solid metal surface portion of the metal layer 110.

During operation, when the card is placed in the electromagnetic field of an HF RFID polling reader (operating, for example, in the RFID frequency band of approximately 13.56 MHz), eddy currents are formed on the metal layer as a reaction effect opposing the applied magnetic field. The eddy currents flow in turns, which form closed loops, and the outermost (largest) turn 123, corresponding to the longest path of the eddy currents, is the most dominant turn in terms of conveyed energy. The representation of the electric currents in FIG. 8 assumes a normal external magnetic field emerging from the plane as illustrated. The second antenna 131 connected to the passive electronic component 12 is routed in the same manner as the first HF RFID antenna 121, so that the second antenna 131, when the metal layer is present, behaves the same as the first HF RFID antenna 121.

In the present invention, for the first HF RFID antenna 121, by virtue of the winding turns of the first set of turns 122 of the antenna that face the outer periphery of the metal layer 110, image electric currents are formed in these turns. With reference to the diagram in FIG. 8, the eddy currents are shown by the thicker arrows indicating the outermost current loop I_{M} on the outer peripheral edge of the metal layer 110. The thinner arrows illustrate the image current I_{A} induced in the first antenna 121.

As illustrated, the induced current will flow from the outermost turn towards the innermost turn encircling the opening 112.

The second antenna 131 connected to the passive electronic component 12 operates in the same manner as the first HF RFID antenna 121.

Routing the first antenna 121 through these two series of turns, as shown, with the

presence of the first slot 113 opening into the opening 112, produces an induced current (I_{A}) flowing in the turns of the second set of turns 124 and an eddy current around the opening that are in the same direction, both in phase with the incident magnetic field.

When both antennas are routed in the same direction, they are in phase, and, when the orientation is different, the antennas are in phase opposition.

Both antennas behave in the same way in this case.

For the direction of the magnetic field considered in FIG. 8, the current I_{A} flowing in the turns of the first antenna 121 in the two sets of turns 122, 124 flows in a counter-clockwise direction and has the same direction of rotation due to the condition of having the same winding direction for the two sets of turns 122, 124. The dominant

outer eddy current loop opposes the incident magnetic field, thus flowing in a clockwise direction along the outer peripheral edge 111 of the metal layer 110, but nevertheless continues in a counter-clockwise direction at the edge of the opening 112, after travelling along one edge of the first slot 113. The opening is therefore a region where the energy through the image electric current I_{A}, picked up from the peripheral eddy currents, the energy from the eddy currents at the edge of the cavity and that from the magnetic flux through the cavity zone, all add together in phase, allowing a maximum amount of energy to be collected in order to power the microcontroller chip 11. This zone delimited by the opening 112 is therefore free of any electrically conductive or magnetic material, but it can be filled with any dielectric material 116 without magnetic properties.

1. A metal smart card configured for contactless near-field operation, the card comprising:
a card body formed by a stack of layers, the stack of layers comprising at least:
a metal layer, the metal layer being delimited by a peripheral edge defining a perimeter of the card body, and the metal layer comprising an opening formed at a distance from the peripheral edge;
a first antenna layer disposed on a first side of the metal layer, distinct from the metal layer,
a second antenna layer, distinct from the first antenna layer and the metal layer,
a chip, disposed opposite the opening in the metal layer,
a first antenna formed on a surface of the first antenna layer, the first antenna being electronically connected to the chip, the first antenna comprising at least one first set of turns comprising at least one turn, called external turn, following the perimeter of the card body, and the first antenna comprising at least one second set of turns comprising at least one turn, called internal turn, surrounding the chip, the first set of turns of the first antenna being distinct from the second set of turns of the first antenna, and the first set of turns of the first antenna being electrically connected to the second set of turns of the first antenna by at least one section of antenna wire,
a passive electronic component,
a second antenna formed on a surface of the second antenna layer, the second antenna being electronically connected to the passive electronic component, the second antenna comprising at least one first set of turns comprising at least one turn, called external turn, following the perimeter of the card body, the first set of turns of the second antenna being disposed opposite the first set of turns of the first antenna, and the second antenna comprising at least one second set of turns comprising at least one turn, called internal turn, surrounding the chip, the second set of turns of the second antenna being disposed opposite the second set of turns of the first antenna, the first set of turns of the second antenna being distinct from the second set of turns of the second antenna, and the first set of turns of the second antenna being electrically connected to the second set of turns of the second antenna by at least one section of antenna wire.

2. The card according to claim 1, comprising at least one electrically insulating layer, the electrically insulating layer being disposed between the metal layer and at least one from among the first antenna layer and the second antenna layer

3. The card according to claim 1, wherein the metal layer is disposed between the first antenna layer and the second antenna layer

4. The card according to claim 1, wherein the second antenna layer is disposed between the first antenna layer and the metal layer.

5. The card according to claim 1, wherein the passive electronic component is opposite the chip.

6. The card according to claim 1, wherein the passive electronic component is laterally offset relative to the opening.

7. The card according to claim 1, comprising a non-magnetic dielectric material filling the opening.

8. The card according to claim 1, wherein the metal layer comprises at least one first slot extending between the opening and a peripheral edge of the metal layer, with an edge of the first slot connecting a perimeter of the opening to the peripheral edge of the metal layer.

9. The card according to claim 1, wherein the metal layer comprises at least one second slot, the second slot being blind and extending into the metal layer from the opening of the metal layer.

10. The card according to claim 1, comprising a module inserted into a cavity in the card body, the module comprising the chip.

11. The card according to claim 1, comprising at least one upper coating layer and one lower coating layer, the two antenna layers and the metal layer being disposed between the upper coating layer and the lower coating layer.

12. The card according to claim 1, wherein the passive electronic component comprises an LED, an OLED, an LED or OLED connected to a diode bridge, a ceramic piezoelectric component, a screen, a sensor, liquid crystals or a capacitor.

13. The card according to claim 2, wherein the metal layer is disposed between the first antenna layer and the second antenna layer.

14. The card according to claim 2, wherein the second antenna layer is disposed between the first antenna layer and the metal layer.

15. The card according to claim 2, wherein the passive electronic component is opposite the chip.

16. The card according to claim 2, wherein the passive electronic component is laterally offset relative to the opening.

17. The card according to claim 2, comprising a non-magnetic dielectric material filling the opening.

18. The card according to claim 2, wherein the metal layer comprises at least one first slot extending between the opening and a peripheral edge of the metal layer, with an edge of the first slot connecting a perimeter of the opening to the peripheral edge of the metal layer.

19. The card according to claim 2, wherein the metal layer comprises at least one second slot, the second slot being blind and extending into the metal layer from the opening of the metal layer.

20. The card according to claim 2, comprising a module inserted into a cavity in the card body, the module comprising the chip.
